(19) United States
(12) Patent Application Publication
(10) Pub. No.: US 2008/0303493 A1
(43) Pub. Date: Dec. 11, 2008

(54) Boost regulator startup circuits and methods

(75) Inventors: Liqiang Hu, Shanghai (CN); Weili Yang, Beijing (CN); Jing Wang, Shanghai (CN)

Correspondence Address: Fountainhead Law Group P.C., Suite 509, 900 Lafayette St., Santa Clara, CA, 95050, US

(73) Assignee: PacificTech Microelectronics, Inc., Grand Cayman (KY)

(21) Appl. No.: 12/002,250

(22) Filed: Dec. 14, 2007

Related U.S. Application Data
(63) Continuation-in-part of application No. 11/876,405, filed on Oct. 22, 2007, now abandoned.

(30) Foreign Application Priority Data
Jun. 11, 2007 (CN) 200710041881.1

(51) Int. Cl. G05F 1/00

(52) U.S. Cl. 323/271

(57) ABSTRACT

Embodiments of the present invention include a method of starting a boost regulator comprising during an initial phase beginning when the boost regulator is powered off, coupling a first current from the input node to the output node to increase a voltage on the capacitor to a first voltage level, during a second phase following the first phase, switching the PMOS transistor and the NMOS transistor, during a third phase following the second phase, turning said PMOS off and switching said NMOS transistor, and during a fourth phase, synchronously switching the PMOS transistor and NMOS transistor.

### CROSS REFERENCE TO RELATED APPLICATIONS

This application is a continuation-in-part of and claims priority to U.S. patent application Ser. No. 11/876,405, filed Oct. 22, 2007, entitled “Boost Regulator Startup Circuits and Methods.” This application claims priority to Chinese Patent Application No. 200710041881.1, entitled “Boost Regulator Startup Circuits and Methods,” filed Jun. 11, 2007.

### BACKGROUND

FIG. 1 is an example of a prior art boost regulator. Circuit 100 in this example includes inductor L1 (102), rectifying diode D1 (103), switch K1 (105), a capacitor 107, and a control circuit (106) which is used to turn switch 105 on and off. Inductor 102 receives an input voltage 101 (“Vᵢₙ”). The other terminal of inductor 102 is coupled to the anode terminal of rectifying diode 103 and a terminal of switch 105. The other terminal of switch 105 is coupled to ground. The cathode terminal of rectifying diode 103 is coupled to Vₒᵤₜ (104), the regulated voltage. The cathode terminal of rectifying diode 103 is also coupled to an input of control circuit 106 and to one terminal of capacitor 107. The other terminal of capacitor 107 is coupled to ground. The control input terminal of switch 105 is coupled to a control output terminal of control circuit 106. This regulator configuration is commonly referred to as a boost regulator or step up regulator because the input voltage Vᵢₙ is “boosted” or “stepped up” to some higher voltage Vₒᵤₜ at output terminal 104.

An example startup of boost regulator circuit 100 may proceed as follows. Circuit 100 is presented with 1.5V, for example, and current flows through the rectifying diode to Vₒᵤₜ. Due to the voltage drop across the rectifying diode, the voltage initially at the output is 1.5V−0.6=0.9V. This 0.9V supplies the control circuit with sufficient power to begin switching the power switch 105. When switch 105 closes, inductor 102 stores up the energy in a magnetic field, and when switch 105 opens the stored energy is discharged into the output capacitor 107. Since the output voltage is related only to the charge transferred to the load capacitor 107 and the size of capacitor 107 and inductor 102, the output can be stepped up to an even higher voltage than the input. The control circuit 106 also uses the output voltage to determine if the output is set to the correct level. This feedback allows control circuit 106 to change the frequency and/or duty cycle of the switching signal sent to the power switch 105, thereby increasing or decreasing the rate and amount of charge delivered to the output in order to obtain a fixed voltage at the output.

Boost regulators are extremely useful for battery applications which may have a limited input voltage. For example, an application may need to have 3.3V for some circuitry on a battery operated device using only one AA battery with a nominal voltage of 1.5V. Since there may be extremely limited space available within these types of devices, the boost regulator and other electronics are required to be very compact. Therefore, a 3 pin regulator solution would be advantageous over a 5 pin solution simply due to the saving in space. In the same way, a solution which limited the number of external components (e.g., by eliminating an external Schottky diode) would also save pins and board space.

One problem for battery operated devices is that the voltage degrades over time and a AA battery may be only supplying 1V or less. If the input at terminal 101 is 1V during startup, current flows through the rectifying diode and the output initially is about 0.4V. This voltage level may not be enough to startup the boost regulator. Accordingly, the drop across the rectifying diode 103 limits the initial supply voltage for the boost regulator control circuit 106 to start operating. One solution to this problem is to provide an additional pin to the regulator in order to supply the control circuitry from the input, but this solution would require additional pins. This example highlights the limitations for 3 pin boost regulators presented with low voltages at their input.

Starting up a boost regulator is problematic in many circuit applications not only due to the drop across the rectifying diode, but also due to the current demands at the output during startup. In order for the voltage to rise to the specified output voltage, the regulator needs to provide enough current to overcome the load requirements. Finally, it is generally desirable to extend the battery life of batteries. It would be advantageous to have a startup circuit that could power up a boost regulator as a battery's voltage begins to decrease at the end of the battery's life.

Thus, there is a need for improved boost regulator startup circuits and methods. The present invention solves these and other problems by providing boost regulator startup circuits and methods.

### SUMMARY

Embodiments of the present invention improve boost regulator startup circuits and methods. In one embodiment the present invention includes a method of starting a boost regulator, the boost regulator comprising an input node for receiving an input voltage, an inductor coupled between the input node and an intermediate node, an NMOS transistor coupled between the intermediate node and ground, a PMOS transistor coupled between the intermediate node and an output node, and a capacitor coupled between the output node and ground, the method comprising during an initial phase beginning when the boost regulator is powered off, coupling a first current from the input node to the output node to increase a voltage on the capacitor to a first voltage level approximately equal to the input voltage less a threshold voltage of the PMOS transistor, during a second phase following the first phase, switching the PMOS transistor and the NMOS transistor to increase the voltage across the PMOS transistor so that the PMOS transistor is a forward biased diode, during a third phase following the second phase, turning said PMOS transistor off and switching said NMOS transistor to increase the voltage on the capacitor to a second predetermined voltage level, and during a fourth phase, synchronously switching the PMOS transistor and NMOS transistor to increase the voltage on the capacitor to a third predetermined voltage level.

In one embodiment the present invention further comprises powering up a first oscillator during said second phase to provide a switching signal to the PMOS transistor and NMOS transistor.

In one embodiment the present invention further comprises powering up a second oscillator during said fourth phase to provide a switching signal to the PMOS transistor and NMOS transistor.

In one embodiment the second oscillator operates at a lower frequency than the first oscillator.

In one embodiment the first oscillator is turned off after the second oscillator is turned on, and wherein the first oscillator and the second oscillator operate together for a predetermined time period before the first oscillator is turned off.

In one embodiment the synchronously switching comprises turning on the NMOS transistor and turning off the PMOS during a first time period, and turning on the PMOS transistor and turning off the NMOS transistor during a second time period.

The following detailed description and accompanying drawings provide a better understanding of the nature and advantages of the present invention.

### BRIEF DESCRIPTION OF THE DRAWINGS

FIG. 1 illustrates a prior art boost regulator circuit.

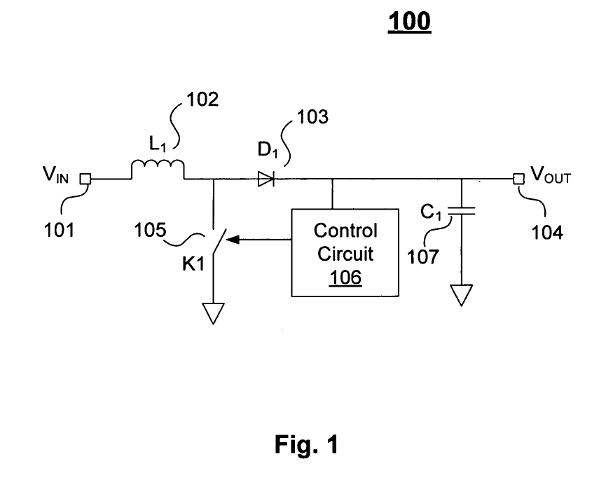

FIG. 2 is an example of a circuit according to one embodiment of the present invention.

FIG. 3 illustrates a method of powering up a boost regulator according to one embodiment of the present invention.

FIG. 4 illustrates an example simulation of one embodiment of the present invention.

### DETAILED DESCRIPTION

Described herein are techniques for starting a boost regulator. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include obvious modifications and equivalents of the features and concepts described herein.

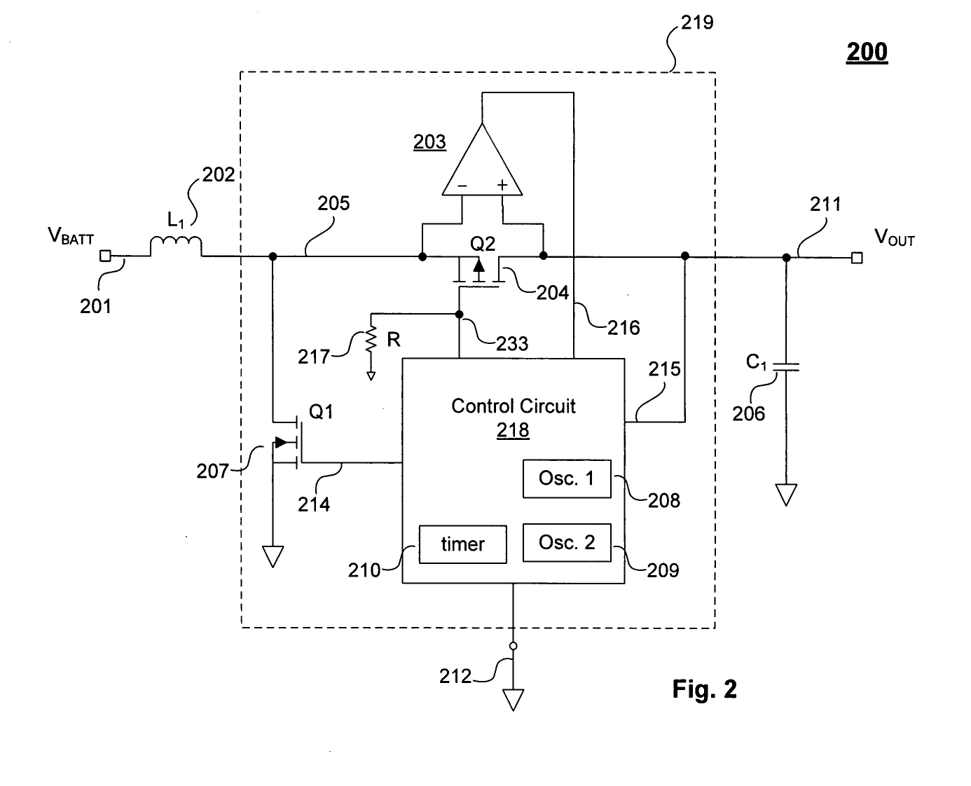

FIG. 2 is an example of a circuit according to one embodiment of the present invention. Boost regulator system 200 includes an input node 201, an inductor 202, a capacitor 206, and an integrated boost regulator 219. The boost regulator 219 includes an output node 211, a ground terminal 212, an intermediate node 205, an amplifier 203, a PMOS transistor 204, a NMOS transistor 207, a pull down resistor 217, and a control circuit 218. Boost regulator system 200 receives a DC voltage V_{BATT} at one terminal of inductor 202. The other terminal of inductor 202 is coupled to the intermediate node 205 which is also coupled to the drain terminal of transistor 207, the source terminal of transistor 204, and the inverting input terminal of amplifier 203. NMOS 207 and PMOS 204 act as power switches in the boost regulator. The source terminal of transistor 207 is coupled to ground. The gate terminal of transistor 207 is coupled to the control circuit 218. The output node 211 is coupled to the non-inverting terminal of amplifier 203, one terminal of capacitor 206, to a power and feedback terminal 215 of control circuit 218, and to the drain terminal of transistor 204. The output node 211 is “Vₒᵤₜ”. The other terminal of capacitor 206 is coupled to ground. Control circuit 218 includes the timer 210, the first oscillator 208, the second oscillator 209, a feedback/power input 215, a PMOS control output 213, a NMOS control output 214, a current reversal signal input 216.

The boost regulator system 200 operates in different phases. During power up of the integrated boost regulator 219, the voltage at the output begins at nearly zero. The pull down resistor 217 allows the PMOS transistor to initially be turned “on” and pass current from V_{BATT} to the intermediate node 205 and through the channel of the PMOS transistor 204 on to the output node 211. This initial phase may allow for a startup current to pass into the control circuit 218 through the feedback/power input 215 and begin biasing the transistors within the control circuit. This phase allows the control circuit to be powered by the output and therefore enable the present embodiment to be implemented with 3 pins. When the voltage reaches a first voltage level, the first oscillator 208 may begin to run the boost regulator in a synchronous mode. Synchronous mode is when NMOS transistor 207 is switched “on” and the PMOS transistor 204 is switched “off” to energize inductor 202 for a first time period, and then NMOS transistor 207 is switched “off” and the PMOS transistor 204 is switched “on” to transfer the energy to capacitor 206 for a second time period. In this manner, successive synchronous switching at an oscillator frequency allows the regulator to boost the output voltage up. This first oscillator 208 may run at an elevated frequency greater than 100 kHz and allow for faster charging during power up. When the current through the PMOS transistor 204 starts reversing back to V_{BATT}, the amplifier 203 sends a signal to the control circuit 218. Control circuit 218 may then switch “off” the PMOS transistor 204 so that its intrinsic body diode can be utilized to prevent current reversal and a discharging of the output capacitor 206. This will allow the output node 211 to continue to increase to a second predetermined voltage level. At this second voltage level the boost regulator can enter the fourth phase in which the PMOS and NMOS transistors are synchronously switched to increase the voltage to a third predetermined voltage level. This third voltage level may be the regulated voltage level of the boost regulator. This fourth phase puts the boost regulator into a normal synchronous boost operation. In one embodiment, a second oscillator frequency may be used to allow the boost regulator to operate in a manner which consumes less power. This frequency may be 100 kHz. In another embodiment, the timer 210 may be used so that the first oscillator stops at one time point and the second oscillator starts at another time point during the startup sequence. For example, the first oscillator is turned off after the second oscillator is turned on, and the first oscillator and the second oscillator operate together for a predetermined time period before the first oscillator is turned off. In another embodiment, a POWER_GOOD signal may be generated that signals the change of oscillators and the beginning of normal operation.

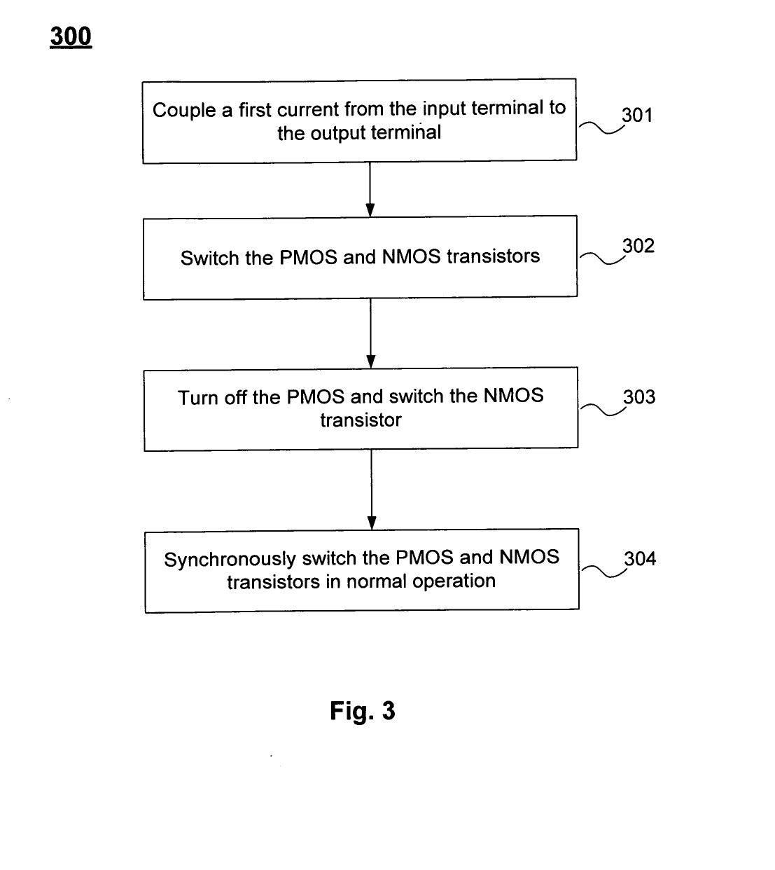

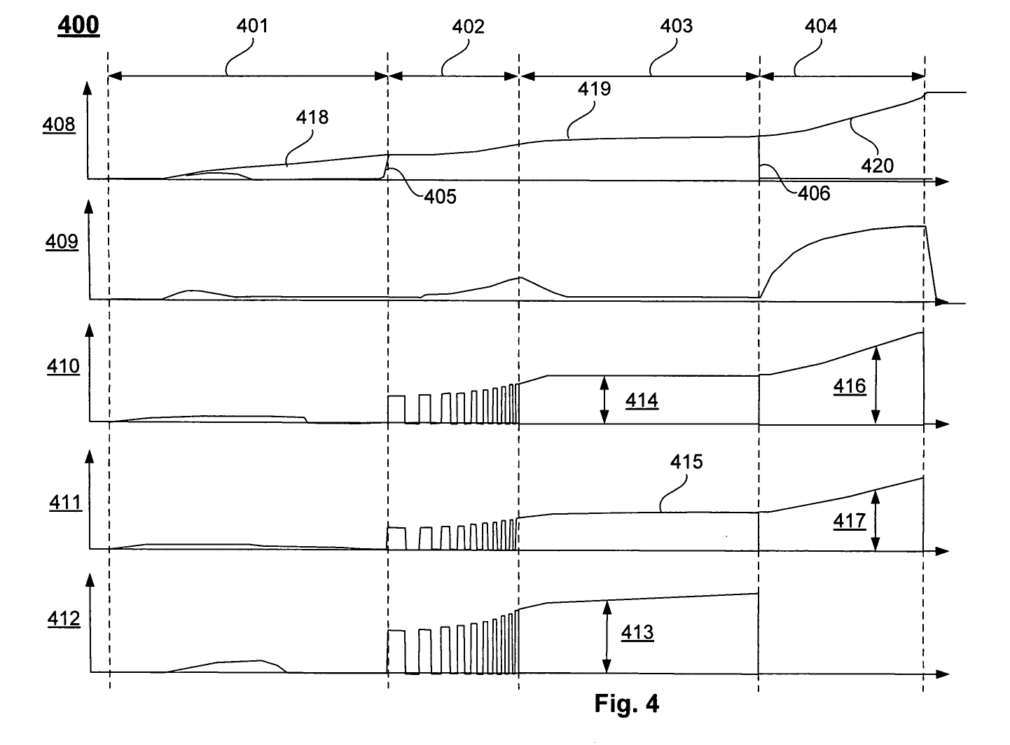

FIG. 3 illustrates a method of powering up a boost regulator according to one embodiment of the present invention. At 301, an initial phase with the boost regulator powered off, the input terminal is coupled to the output terminal. This allows the output to charge to the first voltage level substantially the same voltage as the input, and allow the boost regulator enough voltage to start the next phase, 302. This first voltage level may be approximately equal to the input voltage less a threshold voltage of the PMOS transistor or a level in which the first oscillator may begin operating. For example, if the input node is powered be a 0.9V from a depleted AA battery, then the output node may charge up 0V to 0.9V. FIG. 4, phase 1 (401), illustrates an example simulation of this initial phase. FIG. 4 shows VOUT/POWER_GOOD 408, inductor current 409, NMOS gate voltage 410, PMOS gate voltage 411, and a startup oscillator characteristic 412. Waveform portion 418, 419, and 420 show the VOUT signal rising. Waveform portion 405, 419, and 406 show the POWER_GOOD signal changing. At 302, the NMOS and PMOS transistors are switched to provide additional boost to the voltage. The second phase 302 may be initiated by powering up a first oscillator which provides a switching signal to the PMOS and NMOS transistors. This first oscillator may run at a substantially higher frequency than the normal operation of the switching regulator in order to provide that additional current to increase the voltage at this phase. For example, during the second phase the output node may charge from 0.9V to 1.25V. FIG. 4, phase 2 (402), illustrates an example simulation of the second phase. The POWER_GOOD signal may rise to “not ready” level corresponding to the VOUT voltage level when phase 2 begins as shown at waveform portion 405. At 303, the PMOS transistor is turned off and the NMOS transistor is switched. This third phase 303 may begin when the voltage from the intermediate node to the output node is sufficient to overcome the PMOS intrinsic diode voltage present when the PMOS is turned off. The intrinsic diode acts as a rectifying element which allows the current to flow only toward the output, and therefore continue to charge an output capacitor to a second predetermined voltage level. For example, during the third phase the output node may charge from 1.25V to 1.6V. FIG. 4, phase 3 (403), illustrates an example simulation of the third phase. It is to be understood that while a simulation voltage of 1.6V is used here to ensure functionality, other embodiments may use higher voltages such as 2.5V, for example. During the third phase 403, the startup oscillator characteristic 412 may be switching across a voltage range 413 at a high rate with a high level which increases as the output voltage 419 rises. The PMOS gate voltage 411 is at a high level 415 which “turns off” the PMOS transistor. The NMOS gate voltage 410 may also be switching across a voltage range 414 at a high rate with a high level which increases as the output voltage 419 rises. At 304, the PMOS and NMOS transistors are being synchronously switched in normal boost regulator operation. In one embodiment the switching frequency may be lower to save power in a low power application. For example the oscillator controlling the switching frequency may be running at 100 kHz. During this fourth phase 304 the output node is charged to a third predetermined voltage level. This voltage level may be the regulated voltage output level for the boost regulator. For example, during this phase the output node may be charged from 1.6V to 3.3V, and then the output voltage level maintained at 3.3V. FIG. 4, phase 4 (404), illustrates an example simulation of the fourth phase. The POWER_GOOD signal may go low 406 at the beginning of the fourth phase 404. The NMOS gate voltage 410 may be switching across a voltage range 417 and the PMOS gate voltage 410 may be switching across a voltage range 416.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims. The terms and expressions that have been employed here are used to describe the various embodiments and examples. These terms and expressions are not to be construed as excluding equivalents of the features shown and described, or portions thereof, it being recognized that various modifications are possible within the scope of the appended claims.

What is claimed is:

1. A method of starting a boost regulator, the boost regulator comprising an input node for receiving an input voltage, an inductor coupled between the input node and an intermediate node, an NMOS transistor coupled between the intermediate node and ground, a PMOS transistor coupled between the intermediate node and an output node, and a capacitor coupled between the output node and ground, the method comprising:
during an initial phase beginning when the boost regulator is powered off, coupling a first current from the input node to the output node to increase a voltage on the capacitor to a first voltage level approximately equal to the input voltage less a threshold voltage of the PMOS transistor;
during a second phase following the first phase, switching the PMOS transistor and the NMOS transistor to increase the voltage across the PMOS transistor so that the PMOS transistor is a forward biased diode;
during a third phase following the second phase, turning said PMOS transistor off and switching said NMOS transistor to increase the voltage on the capacitor to a second predetermined voltage level; and
during a fourth phase, synchronously switching the PMOS transistor and NMOS transistor to increase the voltage on the capacitor to a third predetermined voltage level.

2. The method of claim 1 further comprising powering up a first oscillator during said second phase to provide a switching signal to the PMOS transistor and NMOS transistor.

3. The method of claim 2 further comprising powering up a second oscillator during said fourth phase to provide a switching signal to the PMOS transistor and NMOS transistor.

4. The method of claim 3 wherein the second oscillator operates at a lower frequency than the first oscillator.

5. The method of claim 3 wherein the first oscillator is turned off after the second oscillator is turned on, and wherein the first oscillator and the second oscillator operate together for a predetermined time period before the first oscillator is turned off.

6. The method of claim 1 wherein synchronously switching comprising turning on the NMOS transistor and turning off the PMOS during a first time period, and turning on the PMOS transistor and turning off the NMOS transistor during a second time period.
